(19) United States
(12) Patent Application Publication
(10) Pub. No.: US 2025/0130947 A1
(43) Pub. Date: Apr. 24, 2025

(54) CLEAR PREFETCH STREAM ON DETECTION OF PIPELINE FLUSH

(71) Applicant: International Business Machines Corporation, Armonk, NY (US)

(72) Inventors: VIVEK BRITTO, Austin, TX (US); George W. Rohrbaugh, III, Charlotte, VT (US); Bryan Lloyd, Austin, TX (US); Robert A. Cordes, Austin, TX (US)

(21) Appl. No.: 18/490,810

(22) Filed: Oct. 20, 2023

(51) Int. Cl. G06F 12/0862

(52) U.S. Cl. CPC G06F 12/0862

(57) ABSTRACT

According to one embodiment, a method, computer system, and computer program product for managing access to data is provided. The embodiment may include identifying one or more prefetch streams. The embodiment may also include saving a memory access instruction that created or advanced a selected prefetch stream from the one or more prefetch streams. The embodiment may further include detecting a pipeline flush prior to the saved memory access instruction. The embodiment may also include stopping the portion of the selected prefetch stream that follows the saved memory access instruction based on a type of the saved memory access instruction.

### BACKGROUND

The present invention relates generally to the field of computing, and more particularly to memory management.

Modern computers often use multiple memory units with varying speeds and storage sizes. Accordingly, efficient computing involves memory management, a set of techniques for managing data between those memory units to optimize performance. Particularly, processors may predict which instructions are likely to be executed soon, or which data is likely to be used soon, and prefetch those instructions or data to faster, “lower-level” memory.

### SUMMARY

According to one embodiment, a method, computer system, and computer program product for managing access to data is provided. The embodiment may include identifying one or more prefetch streams. The embodiment may also include saving a memory access instruction that created or advanced a selected prefetch stream from the one or more prefetch streams. The embodiment may further include detecting a pipeline flush prior to the saved memory access instruction. The embodiment may also include stopping the portion of the selected prefetch stream that follows the saved memory access instruction based on a type of the saved memory access instruction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for clearing prefetch streams upon detection of pipeline flushes.

FIG. 3 illustrates an exemplary processor set for detection of pipeline flushes.

### DETAILED DESCRIPTION

According to an aspect of the invention, there may be a method to clear prefetch streams upon detection of pipeline flushes. The method may include identifying one or more prefetch streams. The method may also include saving a memory access instruction that created or advanced a selected prefetch stream from the one or more prefetch streams. The method may further include detecting a pipeline flush prior to the saved memory access instruction. The method may also include stopping the portion of the selected prefetch stream that follows the saved memory access instruction based on a type of the saved memory access instruction.

The advantages of this method may include keeping fast, useful memory clear of unnecessary data, thus improving efficiency of the system, such as in the case of an erroneous branch prediction. It further allows for aggressive prefetching without the risk of inefficient locking of the useful memory.

In embodiments, types of the saved memory access instruction include a hardware type instruction and a software type instruction. This may allow the method to achieve its efficiency across many different types of prefetch streams, rather than merely one type.

In embodiments, the type of the memory access instruction is a hardware advance type instruction. Recognizing this has the technical advantage of further achieving efficiency across different types of instructions. In embodiments, the stopping includes pausing the selected prefetch stream. This has the advantage of helping to discern between different types of flushes, for example allowing the system to resume and retain the prefetch stream in case of a store ordering flush, but clear it in other cases. This improves consistency of the efficiency-granting benefits of the method, and reduces risk of clearing useful data from an advantageous position in memory.

In embodiments, the type of the memory access instruction is, more specifically, a load instruction or a store instruction. This distinction further allows a system to respond to the nature of the particular memory access instruction, allowing for more efficiency still, and fewer errors.

In embodiments, upon determining that the type of the memory access instruction is a create type instruction, the stopping may be performed by cancelling the selected prefetch stream. This process has the technical advantage of simply and quickly clearing prefetch streams that do not need to be paused, and helping to prioritize an efficient memory allocation. In embodiments, upon determining that the type of the memory access instruction is an advance type instruction, the stopping may be performed by pausing the selected prefetch stream. This has the advantage of helping to discern between different types of flushes, for example allowing the system to resume and retain the prefetch stream in case of a store ordering flush, but clear it in other cases. This improves consistency of the efficiency-granting benefits of the method, and reduces risk of clearing useful data from an advantageous position in memory. The combination of these methods further has the advantage of broadly addressing a wide variety of potential inefficiencies or errors in the method.

In embodiments, the method further includes loading a prefetch stream from the one or more prefetch streams into a destination cache memory. This brings the advantage of loading the instructions most likely to be used into the fastest practical memory location, while keeping that fast memory location, which is likely to be small in size, free of unnecessary instructions or data.

In embodiments, the detecting is performed by a dedicated prefetch flush detection module. This has the advantage of quickly, efficiently, and consistently performing the detecting without requiring software processing to detect processor events.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to memory management. The following described exemplary embodiments provide a system, method, and program product to, among other things, manage prefetch streams in response to detection of a pipeline flush (or merely “flush”). Therefore, the present embodiment has the capacity to improve the technical field of memory management by clearing, cancelling, or pausing prefetch streams when the associated instructions are flushed, thus freeing up low-level memory.

As previously described, modern computers often use multiple memory units with varying speeds and storage sizes. Accordingly, efficient computing involves memory management, a set of techniques for managing data between those memory units to optimize performance. Particularly, processors may predict which instructions are likely to be executed soon, or which data is likely to be used soon, and prefetch those instructions or data to faster, “lower-level” memory.

Since prefetching to low-level memory often includes speculation about what software might do in the future, might be likely to result in prefetches of instructions that never get executed, or data that never gets used. Since low-level memory also tends to be smaller and faster, loading unnecessary information into and maintaining it in low level memory is an inefficient waste of a valuable resource. However, a pipeline flush may help indicate that certain instructions need no longer be maintained or held in low-level memory. As such, it may be advantageous to detect flushes and, upon doing so, suspend the loading of a prefetch stream or delete it from memory.

According to one embodiment, a prefetch stream management program identifies one or more prefetch streams. The prefetch stream management program then saves an identifier for a memory prefetch instruction associated with one of the prefetch streams. The prefetch stream management program then detects a flush prior to the saved instruction. The prefetch stream management program then clears, cancels, suspends, pauses, or otherwise stops the prefetch stream.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

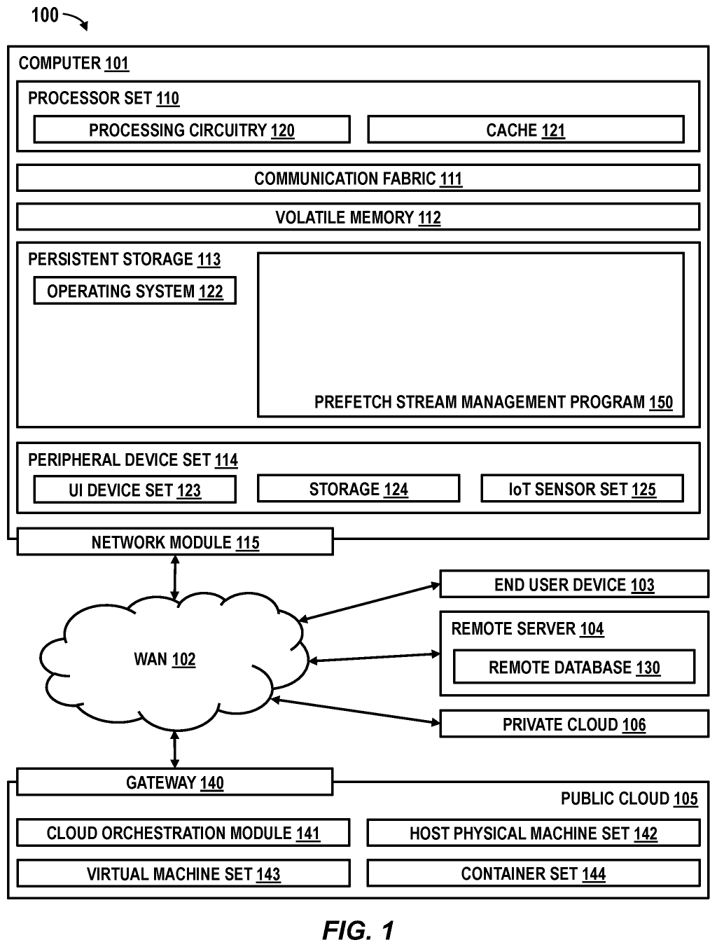

Referring now to FIG. 1, computing environment 100 contains an example of an environment for the execution of at least some of the computer code involved in performing the inventive methods, such as prefetch stream management program 150. In addition to prefetch stream management program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and prefetch stream management program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in prefetch stream management program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in prefetch stream management program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The prefetch stream management program 150 may identify a prefetch stream. The prefetch stream management program 150 may further save an instruction that created or advanced the prefetch stream. The prefetch stream management program 150 may then detect a pipeline flush prior to the saved instruction. The prefetch stream management program 150 may then suspend, clear, or otherwise handle the prefetch stream according to various methods.

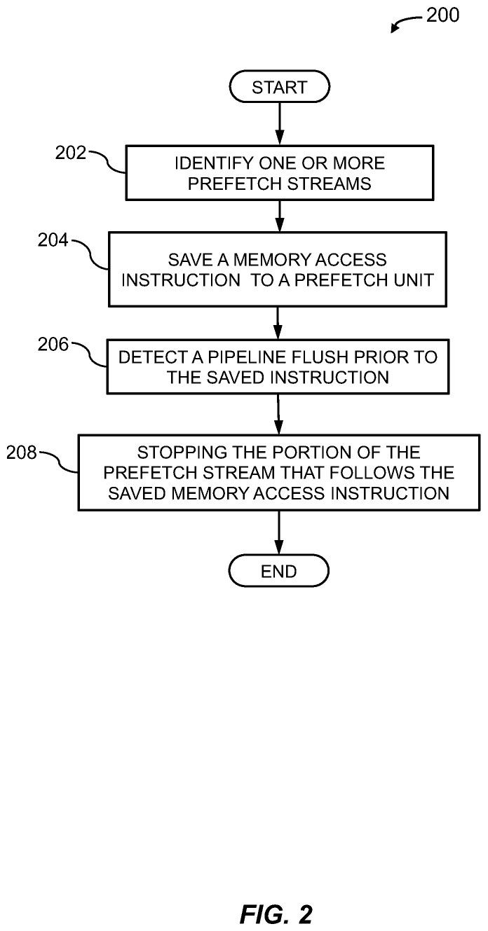

Furthermore, notwithstanding depiction in computer 101, prefetch stream management program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for managing prefetch streams 200 is depicted according to at least one embodiment. At 202, the prefetch stream management program 150 identifies one or more prefetch streams. A prefetch stream may be a set of instructions that may be executed soon, or other data that may be used soon. Prefetching may include loading instructions from a higher-level memory into lower-level memory. A prefetch stream be selected for loading, in the process of loading, or fully loaded into a lower-level memory location. Prefetch streams may be identified by hardware or software functions, including, for example, speculative or predictive functions or pre-programmed determinations.

A prefetch stream may be data in memory pertaining to a set of instructions that may be executed soon, or other data that may be used soon. Data may include instructions, variables used by instructions, or any other data that is predicted to be an efficient use of space in a destination memory module. Prediction or speculation regarding which data should be prefetched may be performed by various methods, including by software, such as a compiler that analyzes program instructions to determine likely patterns in execution; by a developer, especially a developer writing in a “low-level” language, who inserts a software prefetch instruction into code; or by hardware, such as by a processor mechanism like prefetch unit 302 or a dedicated branch predictor. Identifying may be performed by non-speculative means, such as by a “goto” instruction that clearly indicates which instructions are to be performed after a certain instruction is complete, or by any other known method for determining what data to prefetch.

Prefetching may include loading instructions from, for example, a higher-level memory into lower-level memory. Memory need not be divided into higher or lower levels, but may alternatively be framed as different types, such as cache memory, random access memory (RAM), flash memory, a hard disk, a solid state drive, and may include cache 121, volatile memory 112, persistent storage 113, or any other memory or storage module. Prefetching may copy data to the destination memory location. A “higher level” memory module may be relatively large and slow, whereas a “lower level” memory module may be relatively small and fast.

A prefetch stream be identified at various stages, such as a stage where it is selected or identified for loading, in the process of loading, or fully loaded into a destination memory module or location. A prefetch stream may be created or advanced by a prefetch instruction, loaded slowly, such as by loading one or more cache lines at a time, or may be loaded all at once, for example in response to an instruction to prefetch a specific set of instructions.

The prefetch stream management program 150 may identify any number of prefetch streams. In one example, a particular processor architecture may be limited to sixteen prefetch streams in a level one cache, and may maintain all sixteen at once until one is marked for deallocation and replaced. The prefetch stream management program 150 may further identify a prefetch request queue of prefetch streams to be loaded when memory is available.

Then, at 204, the prefetch stream management program 150 saves a memory access instruction that created or advanced a prefetch stream. Saving a memory access instruction may include saving a reference to the instruction, such as an instruction tag or other identifier. A memory access instruction may be any instruction that causes a prefetch stream to be created or advanced, such as a prefetch, load, or store instruction. The memory access instruction may be saved to the cache 121, prefetch unit 302, prefetch flush detection module 304, volatile memory 112, persistent storage 113, or any other storage location capable of storing a reference to an instruction in practice. A memory access instruction may be identified for saving by any method, including by the methods used to identify prefetch streams, or any other hardware or software method.

A memory access instruction may be any instruction that causes a prefetch stream to be created or advanced, such as a prefetch, load, or store instruction. In alternative embodiments, memory access instructions may include any other instructions that are found to lead to the creation or advancement of a prefetch stream through any speculation described at 202. A memory access instruction may be a hardware instruction or software instruction. A create instruction may, specifically, be an instruction that creates a prefetch stream, such as a software prefetch instruction or hardware prefetch instruction, and an advance instruction may, specifically, be a load or store instruction.

In preferred embodiments, the memory access instruction or a reference to the memory access instruction may be saved to the cache 121, prefetch unit 302, prefetch flush detection module 304, or some other fast storage location that serves the efficiency aims of the process for managing prefetch streams 200. Alternatively, the memory access instruction may be volatile memory 112, persistent storage 113, or any other storage location capable of storing a reference to an instruction in practice.

A reference may be an instruction tag or any other identifier. Alternatively, the prefetch stream management program 150 may save the entire memory access instruction, including information necessary to determine priority at 206.

A memory access instruction may be identified for saving by any method, including by the methods used to identify prefetch streams, or any other hardware or software method. For example, the memory access instruction may be identified by prefetch unit 302 or prefetch flush detection module 304 upon entering a processor's instruction queue, or at its execution, or at any other point. Alternatively, the memory access instruction may be identified by a processor and may automatically be saved by the processor to the storage location described above.

The prefetch stream management program 150 may store any number of instructions, either storing many instructions at once or storing multiple different instructions in succession.

Next, at 206, the prefetch stream management program 150 detects a flush prior to the saved instruction. The detecting may be performed by software or, in preferred embodiments, by hardware, including by a dedicated hardware module such as prefetch flush detection module 304. A flush may be triggered as a response to a flush instruction, a branch, or an erroneous memory access instruction. Priority may refer to an order in the instruction queue or by any other ordering of instructions or events. A flush may be detected in the next instruction in an instruction queue, or any pending instruction, including a speculative instruction.

The prefetch stream management program 150 may detect a flush by software or hardware, including by a dedicated hardware module such as prefetch flush detection module 304. A flush may be detected in the next instruction in an instruction queue, or any pending instruction, or a speculative potential future instruction such as an instruction in a prefetch stream.

A flush may be triggered as a response to a flush-inducing instruction, a mispredicted branch, or an erroneous memory access instruction. A flush need not necessarily be identified by a specific instruction, but may be identified upon a determination, such as a determination by the processor, by the prefetch stream management program 150, or by prefetch flush detection unit 304, that a predicted branch was predicted incorrectly, such as due to an erroneous “load” or “store” instruction.

Priority may refer to an order in the instruction queue or by any other ordering of instructions or events. The flush may occur prior to one or more saved instructions, in case more than one instruction is stored.

In a preferred embodiment, the priority of the flush may be determined based on the erroneous instruction that caused the flush. Alternatively, priority of the flush may be determined based on when the flush is identified or by any other principle of ordering instructions or events that may be useful in the process for managing prefetch streams 200.

Then, at 208, the prefetch stream management program 150 stops the prefetch stream associated with the saved memory access instruction, depending on the nature of the saved memory access instruction. Stopping may include clearing, cancelling, pausing, or suspending the prefetch stream.

In at least one embodiment, if the prefetch stream was created by a software prefetch command or other software-based memory access instruction, the prefetch stream management program 150 may clear, cancel, reset, or otherwise stop the prefetch stream.

Furthermore, if the prefetch stream was created by hardware detection, the prefetch stream management program 150 may, again, clear, cancel, reset, or otherwise stop the prefetch stream.

Alternatively, if the prefetch stream was advanced by an advancing instruction, the prefetch stream may pause or suspend the prefetch stream. An advancing instruction may be, for example, a load or store instruction.

Clearing, cancelling, or resetting a prefetch stream may include deleting the prefetch stream or deallocating the prefetch stream in the destination memory. The terms “clear,” “cancel,” and “reset” may be used interchangeably in this context. Deallocating a cancelled prefetch stream may be performed instantly or with higher priority than deallocating a paused prefetch stream. Cancelling a prefetch stream may include cancelling the entire prefetch stream, as the entire prefetch stream may follow after the saved instruction, and therefore after the flush.

Pausing or suspending a prefetch stream may include temporarily stopping the prefetch stream from loading further data or instructions into the destination memory. The terms “pause” and “suspend” may be used interchangeably in this context. A paused prefetch stream may, be resumed if the flush turns out to be erroneous or incomplete, such as a store ordering flush, or may be cleared, cancelled, or reset if the flush truly represents a likelihood that the prefetch stream will not be useful, such as if the memory access instruction truly changes the operations of the computer system to a new memory location, or if no further relevant instructions are identified for a short period of time. The short period of time may be a predetermined amount of time or number of instructions processed, or may be an amount of time necessary for deallocated memory to be replaced, for example as described below.

Pausing may further include deallocating the prefetch stream in the destination memory. Deallocating a paused stream may be performed with a lower priority compared to a cancelled prefetch stream; for example, when a new prefetch stream is identified or selected from a prefetch request queue, it may first replace any cancelled prefetch streams, and then, if the only remaining memory spaces for prefetch streams are for paused prefetch streams, any further new streams may replace paused streams.

Clearing or deallocating a paused prefetch stream may only include clearing or deallocating the portion of the stream that follows the flush instruction, without clearing or deallocating the portion of the stream that was loaded by memory access instructions prior to the flush instruction. Deallocating and reallocating may further follow a “least recently used” principle, where the first stream to be reallocated is the least recently used stream, or may follow a priority system where recency of use and nature of the instruction each factor into reallocation priority.

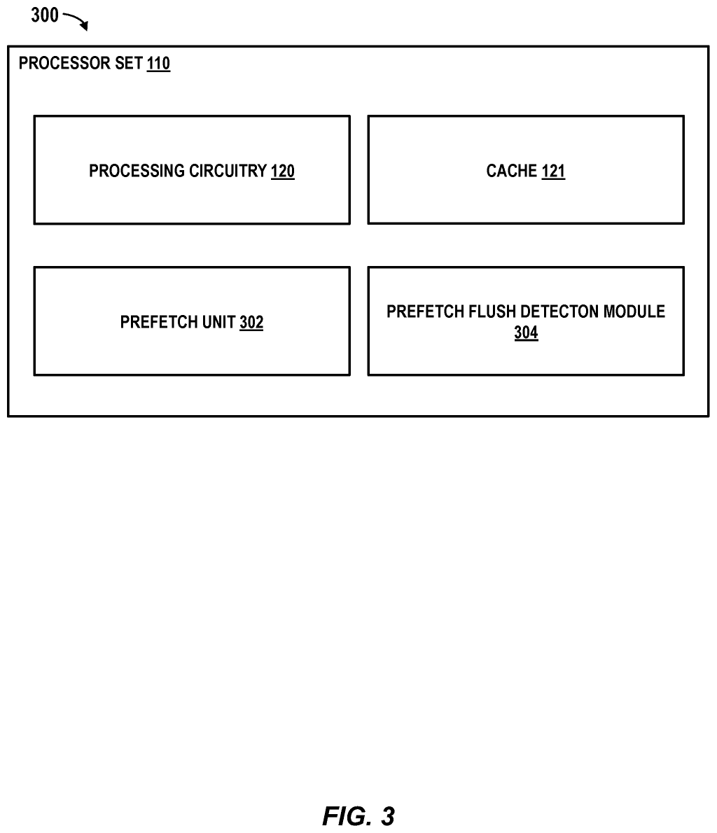

Referring now to FIG. 3, a processor set for the detection of pipeline flushes 300 is depicted according to at least one embodiment. The processor set 110 may include the processing circuitry 120 and cache 121 as described above, and may further include prefetch unit 302 and prefetch flush detection module 304.

Cache 121 may include multiple different “levels” of cache, divided within one module or split among several modules, where a “lower” level of cache may represent a smaller, faster level of cache, and a “higher” level of cache may represent a larger, slower level of cache. As described at FIG. 1, some or all of cache 121 may be located “off chip.”

Prefetch unit 302 may be a module for identifying one or more prefetch streams at 202. Prefetch unit 302 may further identify a prefetch request queue at 202. Prefetch flush detection module 304 may be embedded in or communicatively coupled with prefetch unit 302, a module of cache 121, or any other part of the processor set 110. Prefetch flush detection module 304 may be configured to save memory access instructions at 204 or may detect flushes prior to the saved instructions at 206. Alternatively, the prefetch flush detection module 304 may perform some or all functions of prefetch unit 302, or may include memory that performs some functions of cache 121.

It may be appreciated that FIGS. 2 and 3 each provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method, the method comprising:
identifying one or more prefetch streams;
saving a memory access instruction that created or advanced a selected prefetch stream from the one or more prefetch streams;
detecting a pipeline flush prior to the saved memory access instruction; and
stopping a portion of the selected prefetch stream that follows the saved memory access instruction based on the detected pipeline flush and a type of the saved memory access instruction.

2. The method of claim 1, wherein a type of the saved memory access instruction includes a hardware type instruction and a software type instruction.

3. The method of claim 1, wherein the type of the memory access instruction is a hardware advance type instruction, and the stopping includes pausing the selected prefetch stream.

4. The method of claim 3, wherein the type of the memory access instruction is, more specifically, a load instruction or a store instruction.

5. The method of claim 1, further comprising:
upon determining that the type of the memory access instruction is a create type instruction, performing the stopping by cancelling the selected prefetch stream; and
upon determining that the type of the memory access instruction is an advance type instruction, performing the stopping by pausing the selected prefetch stream.

6. The method of claim 1, further comprising:
loading a prefetch stream from the one or more prefetch streams into a destination cache memory.

7. The method of claim 1, wherein the detecting is performed by a dedicated prefetch flush detection module.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying one or more prefetch streams;
saving a memory access instruction that created or advanced a selected prefetch stream from the one or more prefetch streams;
detecting a pipeline flush prior to the saved memory access instruction; and
stopping a portion of the selected prefetch stream that follows the saved memory access instruction based on the detected pipeline flush and a type of the saved memory access instruction.

9. The computer system of claim 8, wherein a type of the saved memory access instruction includes a hardware type instruction and a software type instruction.

10. The computer system of claim 8, wherein the type of the memory access instruction is a hardware advance type instruction, and the stopping includes pausing the selected prefetch stream.

11. The computer system of claim 10, wherein the type of the memory access instruction is, more specifically, a load instruction or a store instruction.

12. The computer system of claim 11, further comprising:
upon determining that the type of the memory access instruction is a create type instruction, performing the stopping by cancelling the selected prefetch stream; and
upon determining that the type of the memory access instruction is an advance type instruction, performing the stopping by pausing the selected prefetch stream.

13. The computer system of claim 8, further comprising:
loading a prefetch stream from the one or more prefetch streams into a destination cache memory.

14. The computer system of claim 13, wherein the detecting is performed by a dedicated prefetch flush detection module.

15. A computer program product, the computer program product comprising:
one or more computer-readable tangible storage media and program instructions stored on at least one of the one or more tangible storage media, the program instructions executable by a processor capable of performing a method, the method comprising:
identifying one or more prefetch streams;
saving a memory access instruction that created or advanced a selected prefetch stream from the one or more prefetch streams;
detecting a pipeline flush prior to the saved memory access instruction; and
stopping a portion of the selected prefetch stream that follows the saved memory access instruction based on the detected pipeline flush and a type of the saved memory access instruction.

16. The computer program product of claim 15, wherein a type of the saved memory access instruction includes a hardware type instruction and a software type instruction.

17. The computer program product of claim 15, wherein the type of the memory access instruction is a hardware advance type instruction, and the stopping includes pausing the selected prefetch stream.

18. The computer program product of claim 17, wherein the type of the memory access instruction is, more specifically, a load instruction or a store instruction.

19. The computer program product of claim 18, further comprising:
upon determining that the type of the memory access instruction is a create type instruction, performing the stopping by cancelling the selected prefetch stream; and
upon determining that the type of the memory access instruction is an advance type instruction, performing the stopping by pausing the selected prefetch stream.

20. The computer program product of claim 15, further comprising:
loading a prefetch stream from the one or more prefetch streams into a destination cache memory.
